(19) United States
(12) Patent Application Publication
(10) Pub. No.: US 2001/0012433 A1
(43) Pub. Date: Aug. 9, 2001

(54) Device for analyzing optical fibers and method of analysis

(75) Inventor: Ming-Lee Chu, Shiji City (TW)

Correspondence Address: HOGAN & HARTSON L.L.P., 500 S. GRAND AVENUE, SUITE 1900, LOS ANGELES, CA, 90071-2611, US

(73) Assignee: Radiantech, Inc.

(21) Appl. No.: 09/773,177

(22) Filed: Jan. 30, 2001

(30) Foreign Application Priority Data
Nov. 25, 1999 (TW) 088120750

(51) Int. Cl. G02B 6/36

(52) U.S. Cl. 385/136; 385/137

(57) ABSTRACT

A system for examining optical fibers uses a fixture including upper and lower jaws. The lower jaw has an upper surface with a convex arch and a groove passing over the convex arch, where the groove is adapted to receive and hold laterally in place an optical fiber. The upper jaw has a lower surface corresponding to the upper surface of the first lower jaw so that when the first upper jaw is fitted to the first lower jaw, an optical fiber within the groove of the first lower jaw is held in place against the convex arch. First and second orifices extend through the upper jaw and are positioned to intersect a corresponding tangent to an optical fiber held within the groove. A detector inserted within the first and second orifices detects the status of the optical fiber, including the direction of light travel within the fiber.

### BACKGROUND OF THE INVENTION

1. Field of the Invention

The present invention relates to optical communications networks and more specifically to a method for examining fibers used for optical communications to evaluate whether light is propagating through a fiber, determining the direction in which light is propagating and systems facilitating the same.

2. Description of the Related Art

Optical communication networks transmit information by modulating light with information and transmitting the modulated light over optical fibers. Optical communications networks have the advantages of high speed, large bandwidth, low attenuation and immunity to electrical disturbances. Such optical communications networks are widely used in large volume communication networks such as those used by telecommunications companies and such as used for the Internet. Throughout the world companies are investing in developing the technologies and markets for the optical communication networks and an increasing proportion of new long distance communications lines or networks are implemented using optical fibers extending between optical transmitters and receivers on the communication network.

While optical fiber communication networks have significant advantages, optical communications networks present challenges for monitoring and maintenance. For example, it can be difficult to examine an optical fiber to determine if light is passing through the fiber. This is true for two reasons. First, the light passing through a typical fiber is in the near or mid infrared and so cannot be seen by the eye. Second, the light stays within the fiber and cannot easily be detected without breaking the fiber. Needless to say, it is undesirable to break a fiber just to test that fiber.

Fiber examining strategies have been developed that facilitate the testing of fibers as they are installed in the field. An example of such a strategy and a handheld device facilitating that testing is illustrated in U.S. Pat. No. 5,138,690 to Cox; other examining devices in common use are generally similar to the device illustrated in the Cox patent, U.S. Pat. No. 5,138,690. The Cox patent device includes a measuring head that picks up the fiber and bends the fiber to pick up a light signal. When a fiber is bent in this manner, the waveguide structure of the optical fiber breaks down at least in part and light leaks out of the fiber. The light leaking from the fiber is observed by optical detectors in the measuring head of the Cox patent's device. The patent's device has a holding part to pick up the fiber and hold the fiber in place within the measuring head in a controlled manner with a controlled bend in the fiber.

The optical fiber examining device described in the Cox patent provides acceptable fiber examining capabilities, but has disadvantages. It is necessary to pick up each fiber individually to test the fiber. While the process of picking up each fiber is undesirable in that it takes time and labor, the method illustrated by the Cox patent is more undesirable in that it is likely to damage the fiber. The patent's examining device is also expensive. It is desirable to develop an examining strategy that is both less likely to damage fibers when examined and is less expensive.

### SUMMARY OF THE PREFERRED EMBODIMENTS

An aspect of the present invention provides a system for examining optical fibers including a lower jaw having an upper surface with a convex arch and a groove passing over the convex arch, the groove adapted to receive and hold laterally in place an optical fiber within the groove. The system includes an upper jaw having a lower surface corresponding to the upper surface of the lower jaw so that when the upper jaw is fitted to the lower jaw, an optical fiber within the groove of the lower jaw is held in place against the convex arch. At least one orifice extends through an upper surface of the upper jaw and is positioned to intersect a tangent to an optical fiber held within the groove.

Another aspect of the present invention provides a system for examining optical fibers including a first lower jaw having an upper surface with a convex arch and a groove passing over the convex arch. The groove is adapted to receive and hold laterally in place an optical fiber within the groove. The system includes a first upper jaw having a lower surface corresponding to the upper surface of the first lower jaw so that when the first upper jaw is fitted to the first lower jaw. An optical fiber within the groove of the first lower jaw is held in place against the convex arch. First and second orifices extend through an upper surface of the first upper jaw and are respectively positioned to intersect a corresponding tangent to an optical fiber held within the groove.

Still another aspect of the present invention provides a method for examining optical fibers including providing a fixture for holding a fiber in place. The fixture includes a lower jaw having an upper surface with a convex arch and a groove passing over the convex arch, the groove adapted to receive and hold laterally in place an optical fiber within the groove. The fixture includes an upper jaw having a lower surface corresponding to the upper surface of the lower jaw so that when the upper jaw is fitted to the lower jaw, an optical fiber within the groove of the lower jaw is held in place against the convex arch. At least one orifice extends through an upper surface of the upper jaw and is positioned to intersect a tangent to an optical fiber held within the groove. The method includes providing the fixture around an optical fiber to hold the fiber against the convex arch and inserting a detector into the at least one orifice to detect a status of the optical fiber.

### BRIEF DESCRIPTION OF THE DRAWINGS

Implementations of the present invention and advantages of the various aspects of the present invention may be better understood with reference to the below-referenced drawings, which form a part of the present disclosure.

FIG. 1 provides a perspective view of a fixture in accordance with aspects of the present invention for holding an optical fiber for examination.

FIG. 2 provides a perspective partial cut away view showing a fiber installed within the lower jaw of the FIG. 1 fixture.

FIG. 3 shows a cross-sectional view through the FIG. 1 fixture.

FIG. 4 shows an optical communication system including two fixtures in accordance with the present invention.

FIG. 5 is a cross-sectional view that illustrates the insertion of a detector into an orifice of the FIG. 1 fixture.

FIG. 6 illustrates an assembly of a number of the FIG. 1 fixtures.

FIG. 7 illustrates a variation in which a cover is provided for the FIG. 1 fixture.

### DETAILED DESCRIPTION OF THE PREFERRED EMBODIMENTS

The present invention relates to optical communications networks and more specifically to a method for examining fibers used for optical communications to evaluate whether light is propagating through a fiber and an apparatus for facilitating the same. Aspects of the present invention might be used, for example, to evaluate whether a splice or coupling between optical fiber segments effectively couples light from one segment to another.

Preferred embodiments of the present invention provide a system for examining an optical fiber including a fixture that facilitates examination of the fiber by attaching to the fiber in a manner that limits the likelihood of damage to the fiber. The fixture includes an upper and lower jaw positioned on either side of a fiber under test to hold the fiber in place during examination. Preferably the lower jaw has a V-shaped groove extending from side to side of the jaw and a convex arch in the center of the jaw over which the fiber passes when placed on the lower jaw. The upper jaw has a complementary shape to match the shape of the lower jaw and hold the fiber in place along the length of the groove. Most preferably two orifices are provided through an upper surface of the upper jaw and extending through the upper jaw to face on the position of a fiber positioned between the two jaws. The orifices are adapted to receive first and second detectors facing along opposing tangents of a fiber installed between the two jaws.

In a particularly preferred implementation of the present invention, the jaws of the fixture, for example, are injection-molded-plastic and are well suited for mass production. The fixture need not be made with high precision to function acceptably within the examining system. Upper and lower jaws are held together using a simple mechanical clip that fits around exterior portions of the upper and lower jaw to hold the two jaws in fixed positions around the fiber. The fixture consisting of upper and lower jaws is sufficiently inexpensive that is can be installed around a fiber and left in place. The action of clipping the fixture onto the fiber is simple. It can also be used to attach the patch cord during the production process, providing a high-value-added patch cord with the ability to detect a fiber's status.

In a preferred implementation of this strategy, a fiber held within the preferred fixture can be examined by positioning a hand held device so that a detector or a pair of detectors within the device fit into one or both of the orifices in the upper jaw of the fixture. Coupling the one or more detectors of the hand-held device to the fiber is accomplished simply and quickly. The fiber is then examined and then the hand held device is moved to test a next fiber, without changing the position of the fiber. The fixture holds the fiber in a fixed position that will not damage the fiber when the fiber is tested multiple times. This is in contrast to the conventional strategy in which the examining device includes all of the detection optics and electronics and is too expensive to practically leave in place.

Multiple ones of these fixtures can provided for adjacent fibers and attached to one another to provide an orderly fixture in which it is much easier to keep track of which fibers have been tested. In addition to facilitating fiber testing, preferred installations of these fixture assemblies can improve the neatness of fiber assemblies. These fixture assemblies can be provided at positions within an optical fiber communication network where easy testing is advantageous.

When a fiber is positioned between the two jaws, the fiber will be bent along an arch that will create leakage through the wall of the fiber. This leakage can be enhanced as desired by stripping an outer coating from the fiber. Detectors are positioned in each of the orifices of the upper jaw. The light passing through the fiber will leak through one or the other of the orifices to be detected. Since light is detected at one of the detectors and not the other, it is possible to detect the direction that light is passing in the fiber. If no light is detected along either direction of travel, then light is not passing through the fiber. It is thus possible to detect if the fiber is damaged or is improperly joined to another fiber. The fixture and examining system provide a low cost method of examining optical fibers as installed in an optical communication network.

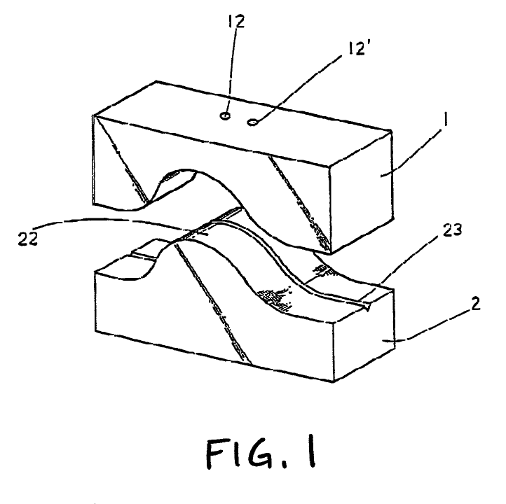

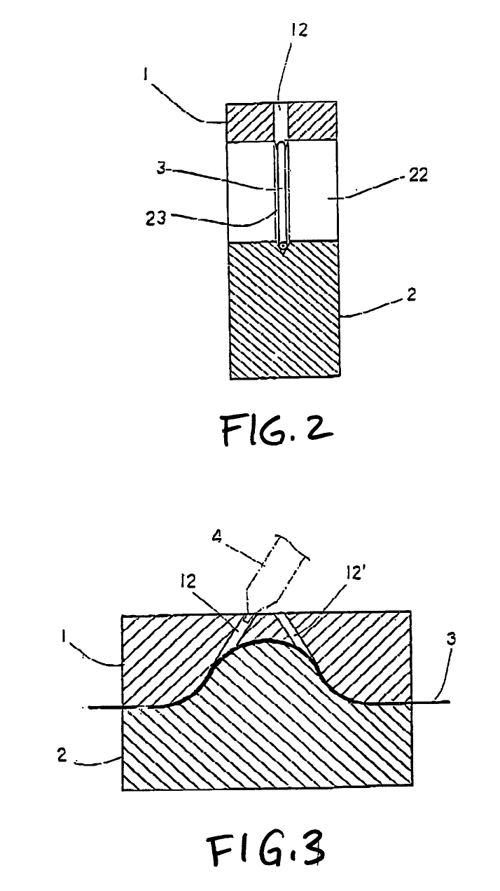

FIGS. 1 and 2 illustrate a particularly preferred fixture adapted to hold a fiber in place and in a preferred shape for examining status of a fiber held between the upper jaw 1 and the lower jaw 2 of the fixture. Preferably the lower jaw has an upper surface 21 provided with a convex arch 22 over which a fiber is bent when installed within the fixture. The size and shape of the convex arch is selected to cause leakage from a fiber 3 held against the arch, in the conventional and well-understood manner. Proper choice of the size and shape of the convex arch allows detection of the status of the fiber with only minimal losses from the fiber. A groove 23 is formed on the surface 21 of the lower jaw 2 to hold the fiber in place laterally on the surface 21 of the lower jaw 2. The groove 23 is illustrated as being V-shaped, but other configurations of grooves can effectively hold a fiber in place. The lower surface of the upper jaw 1 corresponds to the shape of the upper surface 22 lower jaw 2. Most preferably the upper and lower jaws can be connected together to form a mechanically secure unit, for example by fitting a clip around the upper and lower jaws. Alternately, the upper and lower jaws might be held together by fasteners such as screws or a built in fastener.

Two orifices 12, 12′ are provided in the upper jaw to provide access to the bent fiber for an optical detector. As shown in FIG. 3, each of the orifices 12, 12′ extends along an angle toward a position on a bent fiber 3 positioned between the upper and lower jaws. The orifices 12, 12′ are positioned and angled so as to intersect (or nearly intersect) with tangents of the bent fiber on opposite sides of the convex arch in the lower jaw 2. Light leaks from the fiber 3 along the tangents. Note that the orifices are substantially aligned with the groove 23 in the lower jaw 2. The upper jaw 1 including the orifices 12, 12′ and the lower jaw 2 including the groove 23 are formed from injection molded plastic.

Under normal conditions, a detector placed in one of the orifices 12, 12′ will detect light and will detect no light when placed in the other orifice. This shows the direction in which light is propagating within the fiber, as light will leak through the orifice only along the tangent aligned with the orifice along the direction of light propagation. If light is not detected from either orifice, it is an indication that the fiber or another part of the communication network is broken.

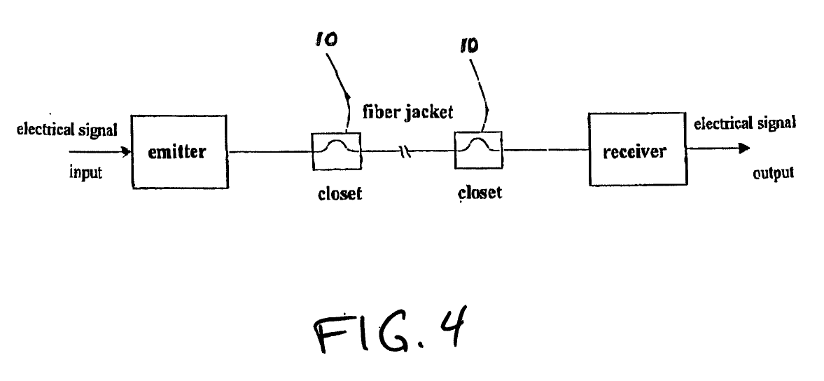

FIG. 4 shows typical positioning of the fixture within the optical switching closets of an optical communications network. As is known in the art, such closets are provided at regular intervals between an emitter and receiver along a switched optical network.

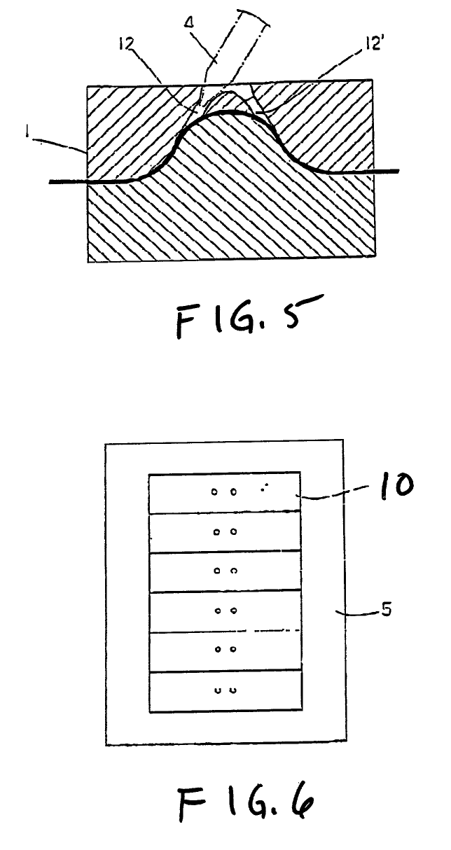

FIG. 5 illustrates an alternate and presently preferred implementation of the fixture in which the orifices 12, 12′ are flared at the opening of the orifices at the upper surface of the upper jaw. The flared openings of the orifices provide easier insertion of a detector into the orifices.

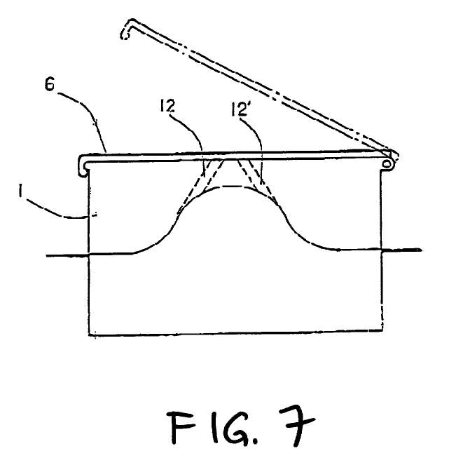

Referring to FIG. 6, in many installations as within the closets of FIG. 4, it is desirable to be able to examine a number of fibers in convenient succession. FIG. 6 shows an assembly of fixtures like those discussed above with reference to FIG. 1, where the individual fixtures are bonded onto a panel 5, for example with an adhesive. Such an assembly not only makes testing more convenient and faster, the assembly also provides order to fiber cabling of the type that is found in a switching closet.

FIG. 7 shows another variation on the fixture in which a cover 6 is provided for the upper surface of the upper jaw 1 to protect the orifices 12, 12′ from dirt or dust accumulation.

In operation, the fixture is fit around a fiber in a desired location, with the fiber seated in the groove on the lower jaw. The jaws are then fixed together by clip, screw or other fastener to hold the fiber in the groove and in position with respect to the orifices. If desired, a portion of the fiber jacket can be removed before assembling the fixture. An operator inserts a detector into one or more of the orifices to detect presence and direction of light passing through the fiber.

Although the present invention has been described in detail with reference to certain presently preferred embodiments, those of ordinary skill in the art will appreciate that various modifications can be made without departing from the invention. Accordingly, the invention is not to be limited to any of the described embodiments thereof but is instead defined by the following claims.

What is claimed:

1. A system for examining optical fibers, the system comprising:
a lower jaw having an upper surface with a convex arch and a groove passing over the convex arch, the groove adapted to receive and hold laterally in place an optical fiber within the groove;
an upper jaw having a lower surface corresponding to the upper surface of the lower jaw so that when the upper jaw is fitted to the lower jaw, an optical fiber within the groove of the lower jaw is held in place against the convex arch; and
at least one orifice through an upper surface of the upper jaw, the at least one orifice extend through the upper jaw and positioned to intersect a tangent to an optical fiber held within the groove.

2. The system of claim 1, wherein a shape of the convex arch is such that an optical fiber held against the arch leaks light along a tangent direction from the optical fiber held against the arch.

3. The system of claim 1, further comprising an optical fiber held between the upper and lower jaws, wherein a shape of the convex arch is such that when the optical fiber is held against the arch leaks light along a tangent direction from the optical fiber held against the arch.

4. The system of claim 3, wherein the upper and lower jaws are plastic.

5. The system of claim 1, wherein the upper and lower jaws are plastic.

6. A system for examining optical fibers, the system comprising:
a first lower jaw having an upper surface with a convex arch and a groove passing over the convex arch, the groove adapted to receive and hold laterally in place an optical fiber within the groove;
a first upper jaw having a lower surface corresponding to the upper surface of the first lower jaw so that when the first upper jaw is fitted to the first lower jaw, an optical fiber within the groove of the first lower jaw is held in place against the convex arch; and
first and second orifices through an upper surface of the first upper jaw, each of the first and second orifices extending through the first upper jaw and positioned to intersect a corresponding tangent to an optical fiber held within the groove.

7. The system of claim 6, further comprising:
a second lower jaw having an upper surface with a convex arch and a groove passing over the convex arch, the groove adapted to receive and hold laterally in place an optical fiber within the groove;
a second upper jaw having a lower surface corresponding to the upper surface of the second lower jaw so that when the second upper jaw is fitted to the second lower jaw, an optical fiber within the groove of the first lower jaw is held in place against the convex arch; and
third and fourth orifices through an upper surface of the second upper jaw, each of the third and fourth orifices extending through the second upper jaw and positioned to intersect a corresponding tangent to an optical fiber held within the groove.

8. The system of claim 7, further comprising a bonding panel holding the first and second lower jaws in fixed relation to one another.

9. The system of claim 8, wherein the bonding panel holds the first and second lower jaws in contact along one side.

10. The system of claim 6, wherein a shape of the convex arch is such that an optical fiber held against the arch leaks light along a tangent direction from the optical fiber held against the arch.

11. The system of claim 6, further comprising an optical fiber held between the upper and lower jaws, wherein a shape of the convex arch is such that when the optical fiber is held against the arch leaks light along a tangent direction from the optical fiber held against the arch.

12. The system of claim 6, wherein the upper and lower jaws are plastic.

13. The system of claim 6, further comprising a dust cover rotatably attached to the upper surface of the upper jaw, the dust cover protecting the first and second orifices in a closed position.

14. A method for examining optical fibers, the method comprising:
providing a fixture for holding a fiber in place, the fixture including:
a lower jaw having an upper surface with a convex arch and a groove passing over the convex arch, the groove adapted to receive and hold laterally in place an optical fiber within the groove;
an upper jaw having a lower surface corresponding to the upper surface of the lower jaw so that when the upper jaw is fitted to the lower jaw, an optical fiber within the groove of the lower jaw is held in place against the convex arch; and
at least one orifice through an upper surface of the upper jaw, the at least one orifice extend through the upper jaw and positioned to intersect a tangent to an optical fiber held within the groove,
providing the fixture around an optical fiber to hold the fiber against the convex arch; and
inserting a detector into the at least one orifice to detect a status of the optical fiber.

15. The method of claim 14, wherein the at least one orifice is two orifices, the method further comprising determining a direction of light travel within the fiber.
